(19) United States
(12) Patent Application Publication
(10) Pub. No.: US 2026/0347042 A1
(43) Pub. Date: Nov. 5, 2026

(54) Utility Jug with Enhanced Venting and Ergonomic Design

(71) Applicant: Lynx Jugs, LLC, Fulshear, TX (US)

(72) Inventors: Patrick Stewart, Fulshear, TX (US); Daniel Tagtow, Austin, TX (US)

(21) Appl. No.: 19/197,563

(22) Filed: May 2, 2025

(51) Int. Cl. B65D 1/20; B29C 49/42; B29C 65/06; B29L 31/00; B65D 25/28; B65D 47/12; B65D 51/16

(52) U.S. Cl. CPC B65D 1/20; B29C 49/428; B29C 65/0672; B65D 25/2885; B65D 25/2894; B65D 25/2897; B65D 47/121; B65D 51/1672; B29L 2031/7172; B65D 2251/20; B65D 2547/066

(57) ABSTRACT

A utility jug is presented. Comprising a jug portion having a body, a pouring aperture and a vent plug assembly. The body comprises a front, a back, a first side, a second side, a bottom and a top. A spout portion removably attached to the pouring aperture of the jug portion, the spout portion comprising a jug coupling assembly, and a spout. The vent plug assembly is installed using a spin welding procedure to provide a secure and leak-proof seal. The vent plug assembly is configured to regulate airflow into the jug portion during pouring. The jug portion further comprises the pouring aperture that selectively mates with the jug coupling assembly using a threading.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The present invention pertains to the field of portable liquid storage devices, specifically utility jugs designed for outdoor use. Traditional utility jugs have inherent limitations that hinder their functionality in certain recreational and professional activities.

These existing jugs often present challenges such as instability when tilted, leading to inadvertent spills, and difficulties in fitting and securing within standard vehicle storage spaces. The dimensions of traditional jugs often prevent them from being stored conveniently in truck beds beneath various types of covers, and lack of ergonomic features makes handling cumbersome.

Addressing these shortcomings, the inventor has developed an innovative utility jug with an enhanced design that includes improved stability features and user-friendly handling characteristics. This new system introduces a novel breathing vent which incorporates a spin welded plug—a technology commonly utilized in other industries, such as high-end coolers, but previously unexplored within the realm of utility jugs. This vent ensures a controlled flow and minimizes the risk of spills, even when the jug is tilted at various angles.

Moreover, the utility jug is designed with integrated tie-down strap inserts and ergonomic handhold indentions. These features ensure secure placement during transportation and ease of use during handling, respectively. Unlike existing solutions, which typically require screw-on plugs, the present invention employs a more sturdy and reliable plug system that enhances ease of use and integrity of the seal.

The structural improvements, combined with the addition of a filter-equipped spout assembly, provide an advanced solution for users seeking a more reliable and convenient liquid storage jug. This assembly is adaptable, allowing it to be used interchangeably with other existing jug designs, therefore extending its utility beyond proprietary applications.

This invention reflects a novel approach to addressing long-standing inefficiencies in the utility jug market by integrating user-friendly design elements with innovative sealing technology to enhance functionality and user satisfaction.

No prior art is known to the Applicant.

### BRIEF SUMMARY OF THE INVENTION

A utility jug 100 is disclosed. Comprising a jug portion 102 having a body 106, a pouring aperture 704 and a vent plug assembly 112. said body 106 comprises a front 500, a back 502, a first side 504a, a second side 504b, a bottom 506 and a top 508. A spout portion 104 removably attached to said pouring aperture 704 of said jug portion 102, said spout portion 104 comprising a jug coupling assembly 118, and a spout 116. said vent plug assembly 112 is installed using a spin welding procedure to provide a secure and leak-proof seal. said vent plug assembly 112 is configured to regulate airflow into said jug portion 102 during pouring. said jug portion 102 further comprises the pouring aperture 704 that selectively mates with said jug coupling assembly 118 using a threading 706.

A method of manufacture 800 for the utility jug 100, the method is disclosed. Comprising forming the jug portion 102 using a blow molding process, wherein said jug portion 102 includes the body 106, the pouring aperture 704, and a vent 702. installing the vent plug assembly 112 into said vent 702 using a spin welding procedure to create a secure and leak-proof seal. producing the spout portion 104 comprising the jug coupling assembly 118, and the spout 116, wherein said jug coupling assembly 118 is configured to selectively mate with said pouring aperture 704 using the threading 706.

The utility jug 100 is disclosed. Comprising the jug portion 102 having the body 106, the pouring aperture 704 and the vent plug assembly 112. said body 106 comprises the front 500, the back 502, the first side 504a, the second side 504b, the bottom 506 and the top 508. the spout portion 104 removably attached to said pouring aperture 704 of said jug portion 102, said spout portion 104 comprising the jug coupling assembly 118, and the spout 116. said vent plug assembly 112 is configured to regulate airflow into said jug portion 102 during pouring. said jug portion 102 further comprises the pouring aperture 704 that selectively mates with said jug coupling assembly 118 using the threading 706. said body 106 comprises a lower handhold indention 200 and a front handhold indention 300. said utility jug 100 is configured to be tilted into a pouring configuration 700 using the lower handhold indention 200 and the front handhold indention 300 for controlled pouring. said lower handhold indention 200 and said front handhold indention 300 provide ergonomic gripping points for tilting and pouring said utility jug 100. said front handhold indention 300 is molded into a portion of said front 500. said lower handhold indention 200 is molded into a portion of said bottom 506.

### BRIEF DESCRIPTION OF THE SEVERAL VIEWS OF THE DRAWING

FIG. 1 illustrates a perspective overview of an utility jug 100.

FIGS. 2A, 2B and 2C illustrate three elevated views of said utility jug 100.

FIGS. 3A, 3B and 3C illustrate perspective overviews of said utility jug 100.

FIG. 4 illustrates a perspective lower view of said utility jug 100, highlighting a lower handhold indention 200.

FIGS. 5A and 5B illustrate two perspective lower views of said utility jug 100.

FIGS. 6A, 6B and 6C illustrate three elevated views of said utility jug 100.

FIGS. 7A and 7B illustrate two elevated side cross-section views of said utility jug 100 in an upright position and a pouring configuration 700, respectively.

FIG. 8 illustrates a method of manufacture 800 for producing the utility jug 100.

FIG. 9 illustrates a perspective exploded overview of said utility jug 100.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers'specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

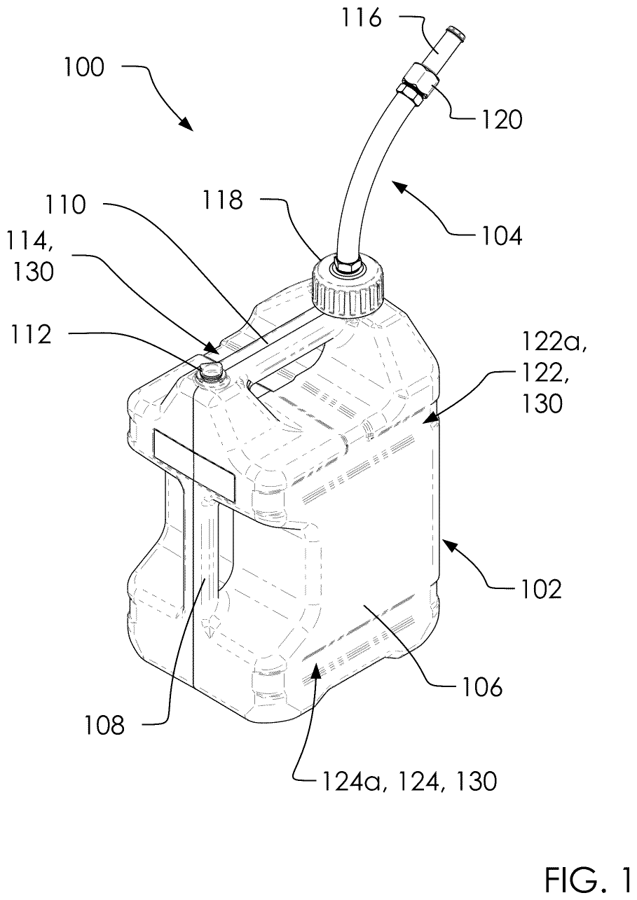

FIG. 1 illustrates a perspective overview of an utility jug 100.

In one embodiment, said utility jug 100 can comprise a jug portion 102 and a spout portion 104. Said jug portion 102 can comprise a body 106, a vertical handle 108, a horizontal handle 110, and a vent plug assembly 112. Said body 106 can comprise an upper strap indention 114, an upper strap indention area 122 including a first upper strap indention 122a and a second upper strap indention 122b, and a lower strap indention area 124 including a first lower strap indention 124a and a second lower strap indention 124b.

Said spout portion 104 can comprise a jug coupling assembly 118, a spout 116, and a filter 120. Said vertical handle 108 and said horizontal handle 110 can facilitate carrying and maneuvering of said utility jug 100, while said upper strap indention area 122 and said lower strap indention area 124 can accommodate straps to secure said utility jug 100 during transportation. Said vent plug assembly 112 can regulate airflow into said jug portion 102, and said filter 120 within said spout 116 can remove impurities from liquid as it is dispensed.

In one embodiment, a portion of said body 106 can comprise one or more strap indentions 130 comprising a surface portion of said body 106 being indented with a width sufficient to receive a strap and prevent that strap from sliding around on a surface of said body 106. Said one or more strap indentions 130 can comprise upper strap indention 114, said upper strap indention area 122 and said lower strap indention area 124. Said one or more strap indentions 130 can extend across entire surfaces of said body 106, such as front 500, back 502, second side 504b, first side 504a, bottom 506, top 508. Said one or more strap indentions 130 can comprise orientations associated with strapping down jugs in vehicles; for example, upper strap indention 114 can comprise a substantially horizontal indention across a top portion of body 106, and said upper strap indention area 122 and said one or more strap indentions 130 can comprise a substantially horizontal indention across the side portions of said body 106. Accordingly, said upper strap indention area 122 and lower strap indention area 124 can selectively receive straps to anchor said utility jug 100 to a vehicle surface.

In one embodiment, said spout portion 104 can be designed to be interchangeable with spout portions of other utility jugs, enhancing its compatibility and versatility across different liquid storage systems.

Said utility jug 100 can be constructed from durable plastic resistant to UV light, temperature variations, and impacts, making it suitable for outdoor use in rugged environments.

The dimensions of said utility jug 100 can be configured to fit within standard truck beds beneath various types of covers, overcoming a common limitation of existing utility jugs.

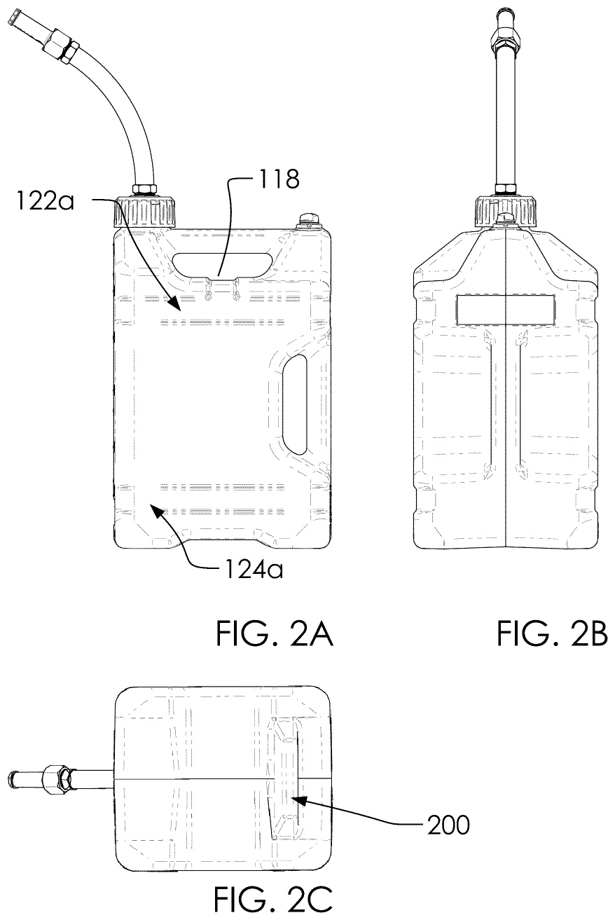

FIGS. 2A, 2B and 2C illustrate three elevated views of said utility jug 100.

In one embodiment, said body 106 can comprise a lower handhold indention 200, which can facilitate gripping and handling of said utility jug 100.

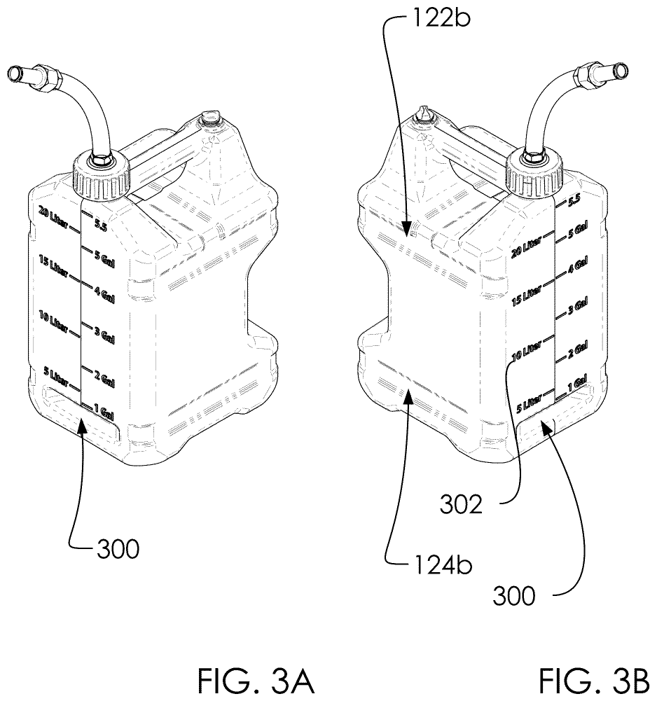

FIGS. 3A and 3B illustrate perspective overviews of said utility jug 100.

In one embodiment, said body 106 can further comprise a front handhold indention 300 and a fluid measure marking 302. Said front handhold indention 300 can provide an additional gripping point on the front of said utility jug 100, complementing said lower handhold indention 200 for improved control. Said fluid measure marking 302 can indicate the volume of liquid contained within said jug portion 102, allowing users to monitor contents without additional tools.

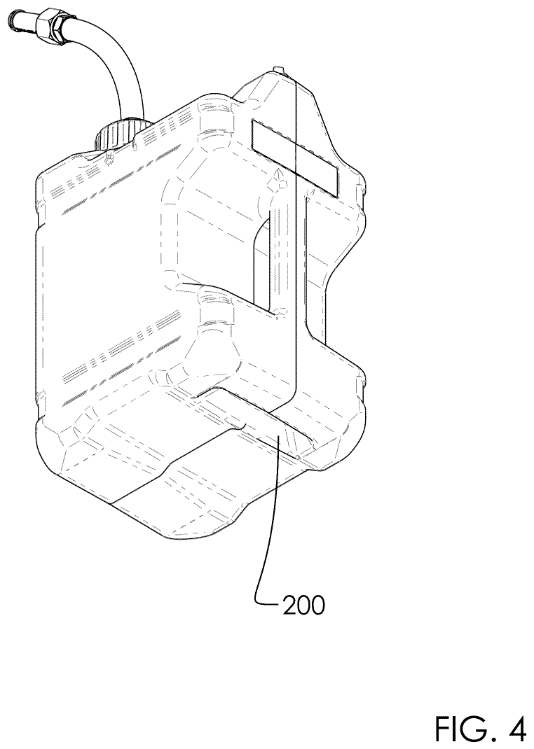

FIG. 4 illustrates a perspective lower view of said utility jug 100, highlighting said lower handhold indention 200.

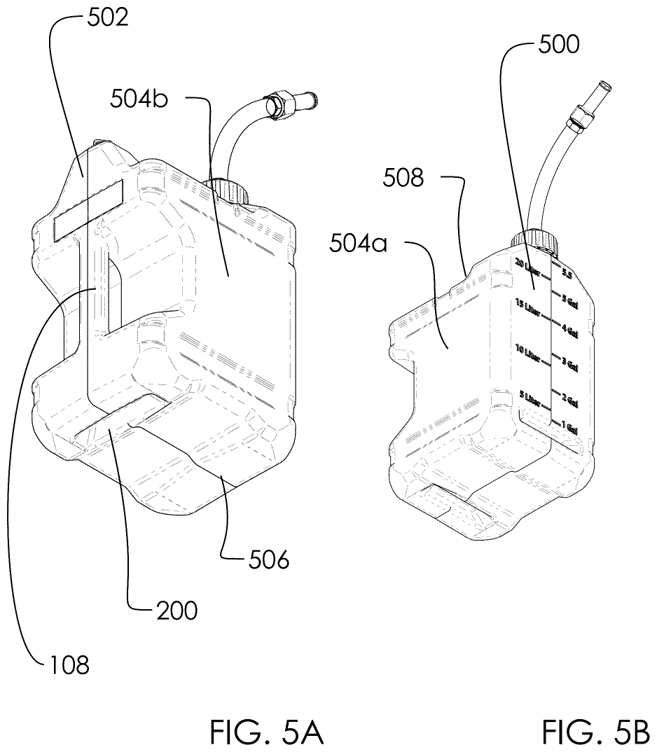

FIGS. 5A and 5B illustrate two perspective lower views of said utility jug 100.

Said body 106 can comprise the front 500, the back 502, the first side 504a, the second side 504b, the bottom 506 and the top 508. Wherein, said spout portion 104 can be arranged proximate to an edge shared by said front 500 and said top 508; Said vertical handle 108 can be molded into a portion of said back 502; Said front handhold indention 300 can be molded into a portion of said front 500; said lower handhold indention 200 can be molded into a portion of said bottom 506; and said horizontal handle 110 can be molded into a portion of said top 508.

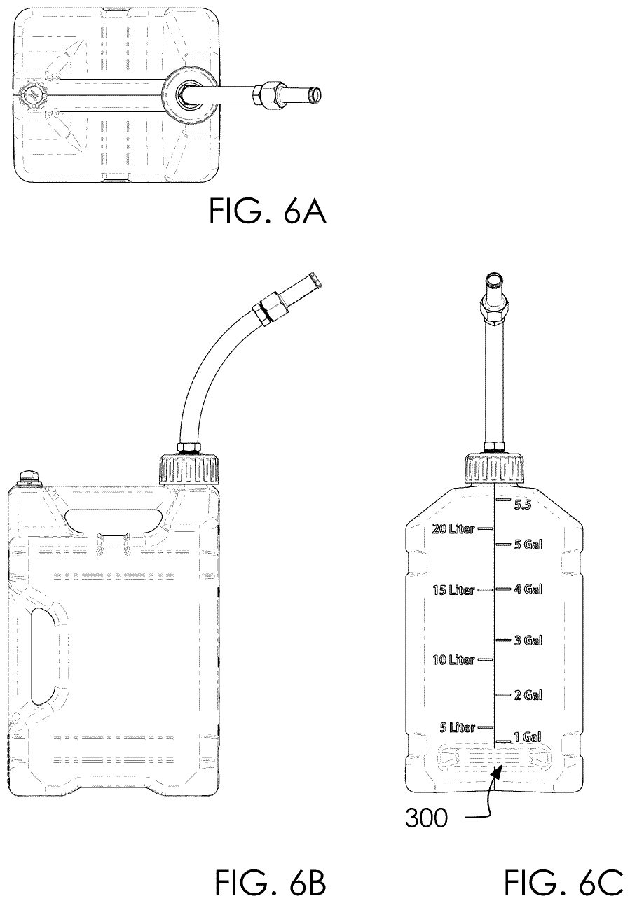

FIGS. 6A, 6B and 6C illustrate three elevated views of said utility jug 100.

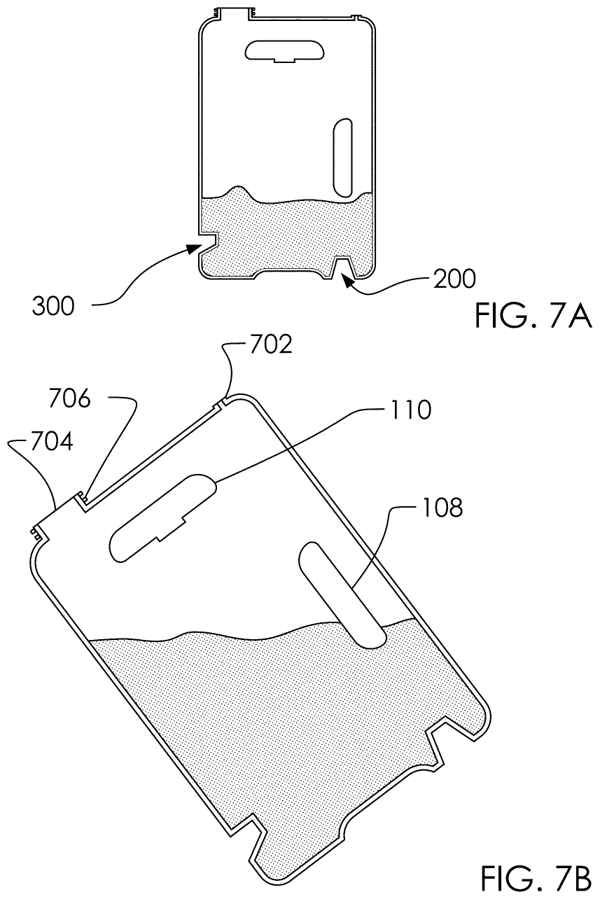

FIGS. 7A and 7B illustrate two elevated side cross-section views of said utility jug 100 in an upright position and a pouring configuration 700, respectively.

In one embodiment, said lower handhold indention 200 and said front handhold indention 300 can facilitate the rotation of said utility jug 100 into said pouring configuration 700. A user can grip said lower handhold indention 200 and/or said front handhold indention 300 to tilt said utility jug 100 for pouring.

Furthermore, said body 106 can comprise a vent 702 and a pouring aperture 704. Said pouring aperture 704 can selectively mate with said jug coupling assembly 118 of said spout portion 104 using a threading 706, as is known in the art, enabling secure attachment and detachment.

Said vent 702, in conjunction with said vent plug assembly 112, can allow air to enter said jug portion 102 during pouring, ensuring a smooth flow through said spout 116. In one embodiment, said vent plug assembly 112 can be installed using a spin welding procedure, which ensures a secure and leak-proof seal. Spin welding is a friction welding technique that joins two plastic parts by rotating one against the other under pressure, generating heat through friction to melt the interface and form a weld upon cooling. This method is particularly effective for creating strong, hermetic seals in plastic components, such as said vent plug assembly 112 in said utility jug 100, enhancing its durability and reliability over traditional screw-on plugs.

In one embodiment, said lower handhold indention 200 and front handhold indention 300 can provide leverage for controlled tilting of said utility jug 100.

The use of spin welding for installing said vent plug assembly 112 provides a stronger, more reliable seal compared to traditional screw-on plugs, reducing the risk of leaks and improving longevity, a significant advancement over conventional utility jug designs.

Said vertical handle 108 can be used for upright carrying, while said horizontal handle 110 can assist in lifting. Said lower handhold indention 200 and front handhold indention 300 can provide ergonomic gripping points for tilting and pouring, reducing user fatigue.

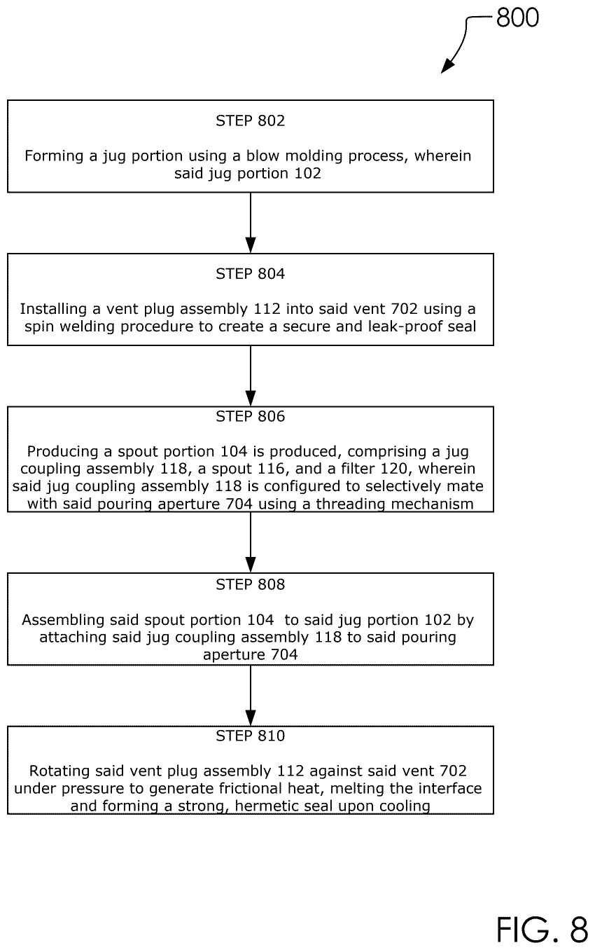

FIG. 8 illustrates a method of manufacture 800 for producing the utility jug 100.

In one embodiment, said method of manufacture 800 can comprise a series of steps to assemble said utility jug 100. First, the jug portion 102 is formed using a blow molding process, wherein said jug portion 102 includes the body 106, the vertical handle 108, the horizontal handle 110, the pouring aperture 704, and the vent 702. Next, the vent plug assembly 112 is installed into said vent 702 using a spin welding procedure to create a secure and leak-proof seal. Then, the spout portion 104 is produced, comprising the jug coupling assembly 118, the spout 116, and the filter 120, wherein said jug coupling assembly 118 is configured to selectively mate with said pouring aperture 704 using said threading 706.

Subsequently, said spout portion 104 is assembled to said jug portion 102 by attaching said jug coupling assembly 118 to said pouring aperture 704. Finally, the fluid measure marking 302 is applied to said body 106 to indicate the volume of liquid that can be contained within said jug portion 102. In one embodiment, the blow molding process can utilize durable plastic resistant to UV light, temperature variations, and impacts, ensuring said utility jug 100 is suitable for outdoor use in rugged environments. The spin welding procedure involves rotating said vent plug assembly 112 against said vent 702 under pressure to generate frictional heat, melting the interface and forming a strong, hermetic seal upon cooling. This method provides a more reliable and durable seal compared to traditional screw-on plugs. Additionally, said spout portion 104 can be designed to be interchangeable with other utility jugs, enhancing its versatility.

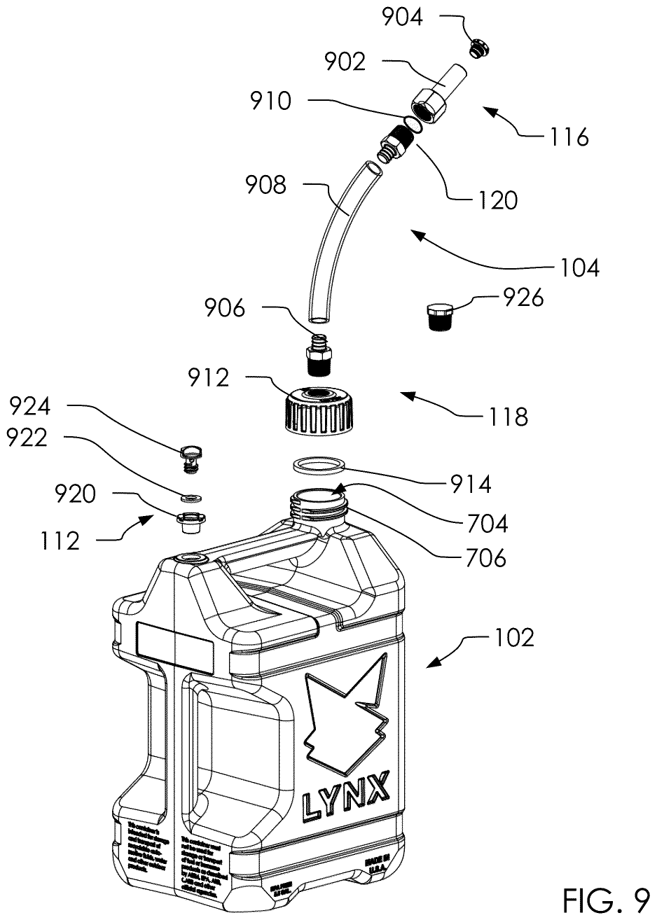

FIG. 9 illustrates a perspective exploded overview of said utility jug 100.

In one embodiment, said spout 116 can comprise a plug 904 and a jug spout 902.

Said spout portion 104 can comprise a tube 908 being connected at one end to jug coupling assembly 118 and at another end to said spout 116. Said jug coupling assembly 118 can comprise a hose adapter 906, a jug cap 912 and a seal 914. Said seal 914 can comprise an O-ring. In one embodiment, said spout portion 104 can further comprise a filter 910 for filtering fluids exiting said jug portion 102.

Said vent plug assembly 112 can comprise a vent insert 920, a washer 922, and a vent 924. Said pouring aperture 704 can comprise the threading 706 configured to selectively connect with said jug cap 912 which can comprise an internal threading (not illustrated).

Said filter 910 can be seated into a threading within said jug spout 902.

In one embodiment, said utility jug 100 can further comprise a cap plug 926. In one embodiment, said cap plug 926 can be used when not using jug spout 902.

### PARTS LIST

the utility jug 100,
the jug portion 102,
the spout portion 104,
the body 106,
the vertical handle 108,
the horizontal handle 110,
the vent plug assembly 112,
the upper strap indention 114,
the spout 116,
the jug coupling assembly 118,
the filter 120,
the second upper strap indention 122b,
the upper strap indention area 122,
the first upper strap indention 122a,
the lower strap indention area 124,
the first lower strap indention 124a,
the second lower strap indention 124b,
the one or more strap indentions 130,
the lower handhold indention 200,
the front handhold indention 300,
the fluid measure marking 302,
the front 500,
the back 502,
the first side 504a,
the second side 504b,
the bottom 506,
the top 508,
the pouring configuration 700,
the vent 702,
the pouring aperture 704,
the threading 706,
the method of manufacture 800,
the jug spout 902,
the plug 904,
the hose adapter 906,
the tube 908,
the filter 910,
the jug cap 912,
the seal 914,
the vent insert 920,
the washer 922,
the vent 924, and
the cap plug 926.

One preferred embodiment of the disclosure can be found in the original claims and are summarized below:

The utility jug 100 can comprise the jug portion 102 having the body 106, the pouring aperture 704 and the vent plug assembly 112. Said body 106 comprises the front 500, the back 502, the first side 504a, the second side 504b, the bottom 506 and the top 508. The spout portion 104 removably attached to said pouring aperture 704 of said jug portion 102, said spout portion 104 comprising the jug coupling assembly 118, and the spout 116. Said vent plug assembly 112 can be installed using a spin welding procedure to provide a secure and leak-proof seal. Said vent plug assembly 112 can be configured to regulate airflow into said jug portion 102 during pouring. Said jug portion 102 further comprises the pouring aperture 704 that selectively mates with said jug coupling assembly 118 using the threading 706.

Said body 106 comprises the lower handhold indention 200 and the front handhold indention 300. Said utility jug 100 can be configured to be tilted into the pouring configuration 700 using the lower handhold indention 200 and the front handhold indention 300 for controlled pouring. Said lower handhold indention 200 and said front handhold indention 300 provide ergonomic gripping points for tilting and pouring said utility jug 100. Said front handhold indention 300 can be molded into a portion of said front 500. Said lower handhold indention 200 can be molded into a portion of said bottom 506.

A portion of the body 106 comprises one or more strap indentions 130 comprising a surface portion of said body 106 being indented with a width sufficient to receive a strap and prevent that strap from sliding around on a surface of said body 106. Said one or more strap indentions 130 comprises upper strap indention 114, the upper strap indention area 122 and the lower strap indention area 124. Said one or more strap indentions 130 can extend across entire surfaces of said body 106, such as front 500, back 502, second side 504b, first side 504a, bottom 506, top 508. Said one or more strap indentions 130 comprises orientations associated with strapping down jugs in vehicles. For example, upper strap indention 114 comprises a substantially horizontal indention across a top portion of body 106, and said upper strap indention area 122 and said one or more strap indentions 130 comprises a substantially horizontal indention across the side portions of said body 106. Accordingly, said upper strap indention area 122 and lower strap indention area 124 can selectively receive straps to anchor the utility jug 100 to a vehicle surface.

Said jug portion 102 further comprises the vertical handle 108 and the horizontal handle 110 for carrying and maneuvering said utility jug 100. Said vertical handle 108 can be molded into a portion of the back 502. And the horizontal handle 110 can be molded into a portion of the top 508.

Said spout portion 104 further comprises the filter 120. Said filter 120 can be configured to remove impurities from the liquid as it can be dispensed through said spout 116.

Said utility jug 100 can be constructed from durable plastic resistant to UV light, temperature variations, and impacts.

The method of manufacture 800 for the utility jug 100, the method can comprise forming the jug portion 102 using a blow molding process, wherein said jug portion 102 includes the body 106, the pouring aperture 704, and the vent 702. Installing the vent plug assembly 112 into said vent 702 using a spin welding procedure to create a secure and leak-proof seal. Producing the spout portion 104 comprising the jug coupling assembly 118, and the spout 116, wherein said jug coupling assembly 118 can be configured to selectively mate with said pouring aperture 704 using the threading 706.

The spin welding procedure comprises rotating the vent plug assembly 112 against the vent 702 under pressure to generate frictional heat, melting the interface, and forming a hermetic seal upon cooling.

The blow molding process uses durable plastic resistant to UV light, temperature variations, and impacts.

Forming the jug portion 102 further comprises integrating the lower handhold indention 200 and the front handhold indention 300 into the body 106 to facilitate tilting and pouring.

Said utility jug 100 comprises the jug portion 102 having the body 106, the pouring aperture 704 and the vent plug assembly 112. Said body 106 comprises the front 500, the back 502, the first side 504a, the second side 504b, the bottom 506 and the top 508. The spout portion 104 removably attached to said pouring aperture 704 of said jug portion 102, said spout portion 104 comprising the jug coupling assembly 118, and the spout 116. Said vent plug assembly 112 can be installed using a spin welding procedure to provide a secure and leak-proof seal. Said vent plug assembly 112 can be configured to regulate airflow into said jug portion 102 during pouring. Said jug portion 102 further comprises the pouring aperture 704 that selectively mates with said jug coupling assembly 118 using the threading 706.

Said utility jug 100 comprises the jug portion 102 having the body 106, the pouring aperture 704 and the vent plug assembly 112. Said body 106 comprises the front 500, the back 502, the first side 504a, the second side 504b, the bottom 506 and the top 508. The spout portion 104 removably attached to said pouring aperture 704 of said jug portion 102, said spout portion 104 comprising the jug coupling assembly 118, and the spout 116. Said vent plug assembly 112 can be configured to regulate airflow into said jug portion 102 during pouring. Said jug portion 102 further comprises the pouring aperture 704 that selectively mates with said jug coupling assembly 118 using the threading 706. Said body 106 comprises the lower handhold indention 200 and the front handhold indention 300. Said utility jug 100 can be configured to be tilted into the pouring configuration 700 using the lower handhold indention 200 and the front handhold indention 300 for controlled pouring. Said lower handhold indention 200 and said front handhold indention 300 provide ergonomic gripping points for tilting and pouring said utility jug 100. Said front handhold indention 300 can be molded into a portion of said front 500. Said lower handhold indention 200 can be molded into a portion of said bottom 506.

The utility jug 100 can comprise the jug portion 102 having the body 106, the pouring aperture 704 and the vent plug assembly 112. Said body 106 comprises the front 500, the back 502, the first side 504a, the second side 504b, the bottom 506 and the top 508. The spout portion 104 removably attached to said pouring aperture 704 of said jug portion 102, said spout portion 104 comprising the jug coupling assembly 118, and the spout 116. Said vent plug assembly 112 can be configured to regulate airflow into said jug portion 102 during pouring. Said jug portion 102 further comprises the pouring aperture 704 that selectively mates with said jug coupling assembly 118 using the threading 706. Said body 106 comprises the lower handhold indention 200 and the front handhold indention 300. Said utility jug 100 can be configured to be tilted into the pouring configuration 700 using the lower handhold indention 200 and the front handhold indention 300 for controlled pouring. Said lower handhold indention 200 and said front handhold indention 300 provide ergonomic gripping points for tilting and pouring said utility jug 100. Said front handhold indention 300 can be molded into a portion of said front 500. Said lower handhold indention 200 can be molded into a portion of said bottom 506.

Said vent plug assembly 112 can be installed using a spin welding procedure to provide a secure and leak-proof seal.

A portion of the body 106 comprises one or more strap indentions 130 comprising a surface portion of said body 106 being indented with a width sufficient to receive a strap and prevent that strap from sliding around on a surface of said body 106. Said one or more strap indentions 130 comprises upper strap indention 114, the upper strap indention area 122 and the lower strap indention area 124. Said one or more strap indentions 130 can extend across entire surfaces of said body 106, such as front 500, back 502, second side 504b, first side 504a, bottom 506, top 508. Said one or more strap indentions 130 comprises orientations associated with strapping down jugs in vehicles. For example, upper strap indention 114 comprises a substantially horizontal indention across a top portion of body 106, and said upper strap indention area 122 and said one or more strap indentions 130 comprises a substantially horizontal indention across the side portions of said body 106. Accordingly, said upper strap indention area 122 and lower strap indention area 124 can selectively receive straps to anchor the utility jug 100 to a vehicle surface.

Said jug portion 102 further comprises the vertical handle 108 and the horizontal handle 110 for carrying and maneuvering said utility jug 100. Said vertical handle 108 can be molded into a portion of the back 502. And the horizontal handle 110 can be molded into a portion of the top 508.

Said spout portion 104 further comprises the filter 120. Said filter 120 can be configured to remove impurities from the liquid as it can be dispensed through the spout 116.

Said utility jug 100 can be constructed from durable plastic resistant to UV light, temperature variations, and impacts.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A utility jug comprising:
a jug portion having a body, a pouring aperture and a vent plug assembly;
said body comprises a front, a back, a first side, a second side, a bottom and a top;
a spout portion removably attached to said pouring aperture of said jug portion, said spout portion comprising a jug coupling assembly, and a spout;
said vent plug assembly is configured to regulate airflow into said jug portion during pouring;
said jug portion further comprises the pouring aperture that selectively mates with said jug coupling assembly using a threading;
said body comprises a lower handhold indention and a front handhold indention;
said utility jug is configured to be tilted into a pouring configuration using the lower handhold indention and the front handhold indention for controlled pouring;
said lower handhold indention and said front handhold indention provide ergonomic gripping points for tilting and pouring said utility jug;
said front handhold indention is molded into a portion of said front;
said lower handhold indention is molded into a portion of said bottom;
a portion of said body comprises one or more strap indentions comprising a surface portion of said body being indented with a width sufficient to receive a strap and prevent that strap from sliding around on a surface of said body;
said one or more strap indentions comprises an upper strap indention, an upper strap indention area and a lower strap indention area;
said upper strap indention comprises a substantially horizontal indention across a top portion of said body;
said upper strap indention area and said lower strap indention area each comprise a substantially horizontal indention across the side portions of said body; and
said upper strap indention area and said lower strap indention area selectively receive straps to anchor said utility jug to a vehicle surface.

2. (canceled)

3. (canceled)

4. The utility jug of claim 1, wherein
said jug portion further comprises a vertical handle and a horizontal handle for carrying and maneuvering said utility jug;
said vertical handle is molded into a portion of the back; and
the horizontal handle is molded into a portion of the top.

5. The utility jug of claim 1, wherein said spout portion further comprises a filter; and
said filter is configured to remove impurities from the liquid as it is dispensed through said spout.

6. The utility jug of claim 1, wherein
said utility jug is constructed from durable plastic resistant to UV light, temperature variations, and impacts.

7. A method of manufacture for an utility jug, the method comprising:
forming a jug portion using a blow molding process, wherein said jug portion includes a body, a pouring aperture, and a vent;
installing a vent plug assembly into said vent using a spin welding procedure to create a secure and leak-proof seal; and
producing a spout portion comprising a jug coupling assembly, and a spout, wherein said jug coupling assembly is configured to selectively mate with said pouring aperture using a threading.

8. The method of manufacture of claim 7, wherein
the spin welding procedure comprises rotating the vent plug assembly against the vent under pressure to generate frictional heat, melting the interface, and forming a hermetic seal upon cooling.

9. The method of manufacture of claim 7, wherein
the blow molding process uses durable plastic resistant to UV light, temperature variations, and impacts.

10. The method of manufacture of claim 7, wherein
forming the jug portion further comprises integrating a lower handhold indention and a front handhold indention into the body to facilitate tilting and pouring.

11. The method of manufacture of claim 7, wherein
said utility jug comprises the jug portion having the body, the pouring aperture and the vent plug assembly;
said body comprises a front, a back, a first side, a second side, a bottom and a top;
The spout portion removably attached to said pouring aperture of said jug portion, said spout portion comprising the jug coupling assembly, and the spout;
said vent plug assembly is installed using a spin welding procedure to provide a secure and leak-proof seal;
said vent plug assembly is configured to regulate airflow into said jug portion during pouring; and
said jug portion further comprises the pouring aperture that selectively mates with said jug coupling assembly using the threading.

12. The method of manufacture of claim 7, wherein said utility jug comprises the jug portion having the body, the pouring aperture and the vent plug assembly;
said body comprises a front, a back, a first side, a second side, a bottom and a top;
The spout portion removably attached to said pouring aperture of said jug portion, said spout portion comprising the jug coupling assembly, and the spout;
said vent plug assembly is configured to regulate airflow into said jug portion during pouring;
said jug portion further comprises the pouring aperture that selectively mates with said jug coupling assembly using the threading;
said body comprises a lower handhold indention and a front handhold indention;
said utility jug is configured to be tilted into a pouring configuration using the lower handhold indention and the front handhold indention for controlled pouring;
said lower handhold indention and said front handhold indention provide ergonomic gripping points for tilting and pouring said utility jug;
said front handhold indention is molded into a portion of said front; and
said lower handhold indention is molded into a portion of said bottom.

13. (canceled)

14. (canceled)

15. (canceled)

16. (canceled)

17. (canceled)

18. (canceled)
